(19) United States
(12) Patent Application Publication
(10) Pub. No.: US 2020/0219212 A1
(43) Pub. Date: Jul. 9, 2020

(54) METHOD AND SYSTEM FOR MANAGING AND ALLOCATING REAL ESTATE RELATED SERVICES

(71) Applicants: DeShawn Steven Robinson, Naples, FL (US); Jesse David Logan, Naples, FL (US)

(72) Inventors: DeShawn Steven Robinson, Naples, FL (US); Jesse David Logan, Naples, FL (US)

(21) Appl. No.: 16/737,432

(22) Filed: Jan. 8, 2020

Related U.S. Application Data
(60) Provisional application No. 62/789,633, filed on Jan. 8, 2019.

(51) Int. Cl. G06Q 50/16; G06Q 10/06; G06Q 40/02

(52) U.S. Cl. CPC G06Q 50/16; G06Q 40/02; G06Q 10/063112

(57) ABSTRACT

A method and system are provided for managing and facilitating the provision of a variety of real estate related services via an IOS/Android application with internet/website administration. Specifically, licensed real estate agents purchase and download the iOS/Android platform application and sign up to be verified users of the system. Based on information provided by the agent, the system verifies and authorizes the agents to use the system. Authorized agents can then submit requests for real-estate related services to be completed for pay, such as hosting open houses, meeting contractors, appraisers, or other service providers at a property, ordering gifts and/or delivering gifts to real estate clients. Other verified users, either real estate agents or other trusted individuals, can bid to complete posted tasks. The system will collect funds from the job posting agent and provide payment to the job completion agent.

### CROSS-REFERENCE TO RELATED APPLICATIONS

This application claims the benefit of U.S. Provisional Application No. 62/789,633 entitled METHOD AND SYSTEM FOR MANAGING AND ALLOCATING REAL ESTATE RELATED SERVICES, filed on Jan. 8, 2019, which is hereby incorporated by reference in its entirety.

### FIELD OF THE INVENTION

The disclosure relates generally to mobile electronic device apps, and more specifically to a system for managing and allocating real estate services.

### BACKGROUND OF THE INVENTION

The sale of residential real estate usually involves a variety of services, many of which are typically scheduled and managed by a real estate agent engaged by the seller of the property. These services might include inspecting the property and repairing items before the property is listed, staging the property in advance of the listing, photographing the property for the listing, showing the property during open houses or otherwise during the listing period, and potentially further inspections and repairs following the acceptance of an offer on the property.

These services usually require the real estate agent to travel to the property to meet and to open the property for the service provider. For a real estate agent with a number of listings and/or an otherwise busy schedule, it is at least challenging if not impossible to accommodate all of the required travel and meetings in a timely and efficient manner. Moreover, for real estate agents busy with their business and/or their personal lives, i.e., most real estate agents, it is necessary to enlist the help of others to meet the travel and meeting requirements.

Real estate agents seeking other individuals to assist with scheduling the above services and traveling to the property to facilitate such services likely will be concerned with the type of individuals whose help they enlist. Some agents will want to make sure that the assisting individuals are other licensed agents, possibly even from the same real estate agency or specific real estate agencies, but potentially any licensed agent in the community in which the property is located, or possibly a neighboring community. Even if the real estate agent is willing to enlist the help of an individual who is not a licensed agent, they likely would want to ensure that the individual has cleared some type of background check or other qualification to provide the services.

The time and effort that is required for an agent to seek out, identify, qualify, hire, and possibly train and/or instruct, such an individual to assist with the above services is significant and detracts from the time and effort that the agent can be spending on developing their business and also time spent on their personal lives. Currently there is no method or system for managing and allocating these real estate related services for the agent.

In addition to real estate agents seeking others to help with providing real estate related services for the agent, other individuals, including other licensed real estate agents, in the same real estate agency or other agencies, often look for opportunities to get involved in the real estate services work in their community. These could be newly licensed real estate agents, licensed real estate agents new to the community or reentering the market after time off, individuals who are considering becoming a licensed real estate agent, or other individuals who are interested in the real estate field generally. These individuals may be willing to assist other real estate agents with the services identified above. If these individuals are new to the real estate market in the community or otherwise not yet connected in the real estate community, they likely have no way of connecting with real estate agents seeking assistance in order to offer their assistance for these services.

Real estate agents also look for, seek out, and require additional methods and ways to advertise or feature their listings to other real estate agents that would provide greater exposure for such listings among fellow real estate agents. Exposure to such featured listings could lead to a sale of the property. In addition, exposure to such featured listings might also lead another agent to request the ability to host an open house at another agent's listing, whether that agent is within the same real estate agency or brokerage or another agency or brokerage.

In today's world and prior to the invention described herein, a real estate agent needing or desiring assistance with the above-referenced services would have to create and work through their network of individuals to identify others who might be interested in and assisting, and qualified to assist, with those services. In addition, they would have to arrange the information and logistics for getting the assisting individual involved and negotiate and also arrange for a potential payment for that individual's assistance.

Likewise, an agent or other individual interested in assisting with the above-referenced services would have to establish and/or work through a network of individuals to find opportunities for assisting, attempt to prove themselves to be qualified to assist with the services, and then negotiate a payment and arrange to receive such payment.

### BRIEF SUMMARY OF THE INVENTION

The systems and methods described herein provide an improved mechanism for arranging, facilitating, and managing the provision of real estate related services. As described hereinafter, embodiments of the present disclosure provide systems and methods that may qualify individuals who might be seeking assistance with real estate related services and individuals who might be interested in assisting with real estate related services, assist individuals in identifying, listing, and describing real estate related services for which assistance is needed, pair qualified individuals who are seeking assistance with real estate related services with individuals who are interested in assisting with real estate related services, provide a mechanism to manage and facilitate the provision of the real estate related services, confirm that the service(s) have been performed as expected, and facilitate and process a payment from the person seeking the assistance to the person providing the assistance.

Specifically, the present disclosure provides a system that may be accessed by a user on a mobile or other computing device through an iOS or Android platform or alternatively through a web-based application.

In some embodiments of the present disclosure, the system, through a central computer, may perform at least one of the following functions, including authorizing individuals to use the system and to sign up and log into the system using a username and password, qualifying users of the system through license verifications or other type of background checks, creating posts for view by others or accepting tasks related to real estate services, posting tasks related to real estate services for other users to view, posting real estate listings offered by users of the system, allowing qualified users to accept tasks related to real estate services that are posted by other users, connecting users who have posted tasks and users who have accepted those tasks to coordinate the completion of the tasks related to real estate services, receiving notifications from users accepting the tasks that the tasks have been completed, notifying the users posting the tasks that the tasks have been completed, and accepting payment and account information from the users of the system to facilitate payment from users posting tasks to users completing those tasks.

The present disclosure further provides a method for managing and facilitating the provision of real estate related services. The method may include the steps of authorizing individuals to use the system and to sign up and log into the system using a username and password, qualifying users of the system, through license verifications or other types of background checks, to create posts for view by others or to accept tasks related to real estate services, receiving information through the system from a user concerning real estate related services and tasks with which the user seeks assistance (such as hosting an open house, opening a house for an inspector, contractor, or other worker needing access to the house, etc.), posting information related to real estate services and tasks for view by other users, posting real estate listings offered by users of the system, receiving information from qualified users indicating their intent to accept the real estate related services and tasks that are posted by other users, connecting users who are seeking assistance with real estate related services and tasks with users who have indicated their desire to accept and perform those tasks coordinating the completion of the tasks related to the real estate services, receiving notifications from users accepting the tasks that the tasks have been completed, notifying the users posting the tasks that the tasks have been completed, and accepting payment and account information from the users of the system to facilitate the payment from users posting tasks to users completing those tasks.

The present disclosure further provides a system and method that may be branded or labeled for any one or more specific real estate firm(s) and available for its or their specific and desired purpose(s), as described herein.

Outlined broadly hereinabove are certain features of the disclosure that will be more specifically described below in the detailed description with respect to the figures and drawings presented herein. Other features of the present disclosure will be readily apparent and understood by those of ordinary skill in the art upon reading the broad descriptions above and the detailed descriptions below. The detailed description includes exemplary embodiments of the present disclosure, and it should be understood that the disclosure is capable of being presented in other embodiments and being performed and practiced in various ways which would be understood to a person of ordinary skill reviewing the details of this disclosure.

### BRIEF DESCRIPTION OF THE DRAWINGS

The novel features believed characteristic of the disclosed subject matter will be set forth in any claims that are filed. The disclosed subject matter itself, however, further objectives, and advantages thereof, will best be understood by reference to the following detailed description of an illustrative embodiment when read in conjunction with the accompanying drawings, wherein:

FIG. 1 is a block diagram of a system in accordance with example implementations of the present disclosure.

FIG. 2A illustrates an example flow chart depicting a method in accordance with example implementations of the present disclosure.

FIGS. 2B through 2Q illustrate example screen shots in accordance with example implementations of the present disclosure.

### DETAILED DESCRIPTION OF ILLUSTRATIVE EMBODIMENTS

Reference now should be made to the drawings, in which the same reference numbers are used throughout the different figures to designate the same components.

It will be understood that, although the terms first, second, third, etc. may be used herein to describe various elements, these elements should not be limited by these terms. These terms are only used to distinguish one element from another element. Thus, a first element discussed below could be termed a second element without departing from the teachings of the present disclosure.

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises” and/or “comprising” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

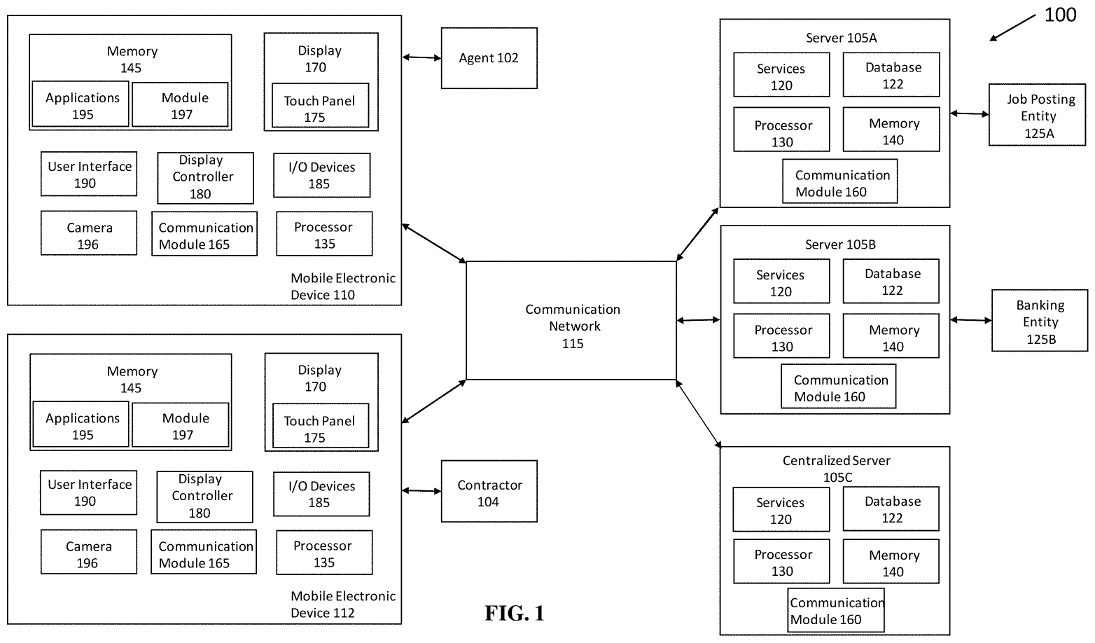

FIG. 1 illustrates a system 100 for providing agent 102 (real estate agent) and contractor 104 information to a centralized repository. For example, service parameter information may be submitted to a central repository for confirming the service parameter information as a job that may be completed by a contractor 104. The system 100 includes one or more servers 105 that are configured to communicate with at least one of a first mobile electronic device 110 and a second mobile electronic device 112 over a communication network 115. In embodiments, the first mobile electronic device 110 and the second mobile electronic device 112 may be a mobile phone (e.g., a smartphone device); a tablet computer; a personal digital assistant (PDA); or the like. In embodiments, the first and second mobile electronic devices 110,112 are configured to communicate with one or more services 120 provided by the servers 105. Services 120 may include job posting confirmation offered by a job posting entity 125A, job offer confirmation offered by a job posting entity 125A, banking services offered by a banking entity 125B, etc.

As shown in FIG. 1, system 100 includes multiple servers 105A,105B that are associated with entities associated with a job posting or banking process. For example, server 105A may be associated with a job posting entity 125A and server 105B may be associated with a banking entity 125B. Server 105C may be configured as a centralized server that provides repository functionality to servers 105A and 105B. In an implementation, server 105C is configured to receive and store digital content (e.g., data representing an agent's information, data representing a contractor's information, data representing a job posting) from one or more first or second mobile electronic devices 110,112. In turn, servers 105A,105B are provided access to the digital content via server 105C. As an example, the job posting entity 125A may wish to access server 105C by way of server 105A to receive the data representing the agent's job posting information to determine whether to approve a job posting for the job posting entity 125A. As another example, the banking entity 125B may wish to access server 105C via server 105B to receive data representing an agent's banking information and a contractor's banking information to properly allocate funds for a completed job.

It is noted that servers 105A,105B,105C may be implemented in a number of ways. For example, servers 105A,105B,105C may be implemented as physical servers, virtual servers (e.g., server functionality implemented within a cloud computing architecture), combinations thereof, or the like.

Banking entity 125B may offer various transaction opportunities (transfer of funds, holding of funds, etc.) to agent 102 and contractor 104. Banking entity 125B can include a private, public, or institutional entity (e.g., a financial institution) that manages funds and may make funds available to at least one of agent 102 and contractor 104. It is understood that banking entity 125B may include, but is not limited to: a bank, a commercial lending entity, a commercial sub-lending entity, or the like.

The contractor 104 may include an individual receiving funds in response to a completed job that had originally been posted by an agent 102. As described herein, agent 102 and contractor 104 are users of the first and second mobile electronic devices 110,112. The agent 102 may utilize the first mobile electronic device 110 to post jobs for approval by the job posting entity 125A. The contractor 104 may utilize the second mobile electronic device 112 to apply for and/or accept jobs posted by agent 102. Additionally, agent 102 may send confirmation information to banking entity 125B via first mobile electronic device 110 in order to allow for funds to transfer to contractor 104 through second mobile electronic device 112 once contractor 104 has completed a job posted by agent 102. However, it is understood that agent 102 and contractor 104 may utilize first and second mobile electronic devices 110,112 to interface with other third-party services.

As shown in FIG. 1, the servers 105A,105B,105C and first and second mobile electronic devices 110,112 each include a respective processor 130,135 and a respective memory 140,145. The processors 130,135 provide processing functionality for the servers 105A,105B,105C and the first and second mobile electronic devices 110,112, respectively. The processors 130,135 may include any number of processors, micro-controllers, or other processing systems and resident or external memory for storing data and other information accessed or generated by the servers 105A,105B,105C and/or the first and second mobile electronic devices 110,112. The processors 130,135 may execute one or more software programs (e.g., modules) that implement techniques described herein.

The memory 140,145 is an example of tangible computer-readable media that provides storage functionality to store various data associated with the operation of the servers 105A,105B,105C and the first and second mobile electronic devices 110,112, such as application software code or other data to instruct the processors 130,135 and other elements of the servers 105A,105B,105C (and first and second mobile electronic devices 110,112) to perform the steps described herein.

The servers 105A,105B,105C are communicatively coupled to the first and second mobile electronic devices 110,112 over a communication network 115 through communication modules 160,165 included in the servers 105A,105B,105C and the first and second mobile electronic devices 110,112, respectively. The communication modules 160,165 may be representative of a variety of communication components and functionality, including, but not limited to: one or more antennas; a browser; a transmitter and/or receiver (e.g., radio frequency circuitry); a wireless radio; data ports; software interfaces and drivers; networking interfaces; data processing components; and so forth.

The communication network 115 may comprise a variety of different types of networks and connections that are contemplated, including, but not limited to: the Internet; an intranet; a satellite network; a cellular network; a mobile data network; wired and/or wireless connections; and so forth.

Wireless networks may comprise any of a plurality of communications standards, protocols and technologies, including, but not limited to: Global System for Mobile Communications (GSM), Enhanced Data GSM Environment (EDGE), high-speed downlink packet access (HSDPA), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11 g and/or IEEE 802.11n), voice over Internet Protocol (VoIP), Wi-MAX, a protocol for email (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), and/or Instant Messaging and Presence Service (IMPS), and/or Short Message Service (SMS)), or any other suitable communication protocol.

As shown in FIG. 1, the first and second mobile electronic devices 110,112 include a touch-sensitive display 170, which can be implemented using a liquid crystal display, an organic light emitting diode display, or the like. In some embodiments, the touch-sensitive display 170 may include a touch panel 175. The touch panel 175 may be, but is not limited to: a capacitive touch panel, a resistive touch panel, an infrared touch panel, combinations thereof, and the like. Thus, the display 170 may be configured to receive input from a user and display information to the user of the first and second mobile electronic devices 110,112. For example, the display 170 displays visual output to the user. The visual output may include graphics, text, icons, video, interactive fields configured to receive input from a user, and any combination thereof (collectively termed “graphics”). In some embodiments, some or all of the visual output may correspond to user-interface objects, further details of which are described below.

The display 170 is communicatively coupled to a display controller 180 that is configured to receive and/or transmit electrical signals to the touch-sensitive display 170. In an implementation, the touch panel 175 includes a sensor, an array of sensors, or the like, configured to accept input from a user based upon haptic and/or tactile contact. The touch panel 175, in combination with the display controller 180 (along with any associated modules and/or sets of computer-readable instructions in memory 145), detects a point of contact (or points of contact), as well as any movement or breaking of the contact, on the touch panel 175 and converts the detected contact (e.g., a finger of the user, a stylus, etc.) into electrical signals representing interactions with user-interface objects (e.g., buttons, custom views, icons, web pages, images, web page links, etc.) that are displayed through the display 170. The first and second mobile electronic devices 110,112 may each further include one or more input/output (I/O) devices 185 (e.g., a keypad, buttons, a wireless input device, a thumbwheel input device, a trackstick input device, and so on). The I/O devices 185 may include one or more audio I/O devices, such as a microphone, speakers, and so on. Thus, I/O devices 185 may include a physical (e.g., mechanical) keyboard configured to receive user input. In an implementation, the keyboard may be integrated with the first and second mobile electronic devices 110,112, or the keyboard may be a peripheral device that is configured to interface with the devices 110,112 (e.g., via a USB port, etc.).

The first and second mobile electronic devices 110,112 are illustrated as including a user interface 190, which is storable in memory 145 and executable by the processor 135. The user interface 190 is representative of functionality to control the display of information and data to users of the first and second mobile electronic devices 110,112 via the display 170. In some implementations, the display 170 may not be integrated into the first and second mobile electronic devices 110,112 and may instead be connected externally using universal serial bus (USB), Ethernet, serial connections, and so forth. The user interface 190 may provide functionality to allow the user to interact with one or more applications 195 (e.g., apps) of the first and second mobile electronic devices 110,112 by providing inputs via the touch panel 175 and/or the I/O devices 185. For example, the user interface 190 may cause an application programming interface (API) to be generated to expose functionality to an application 195 to configure the application for display by the display 170 or in combination with another display. In embodiments, the API may further expose functionality to configure the application 195 to allow the user to interact with an application by providing inputs via the touch panel 175 and/or the I/O devices 185.

Applications 195 (e.g., software subroutines configured for performing specific tasks, etc.) may comprise software that is storable in memory 145 and executable by the processor 135, to perform a specific operation or group of operations to furnish functionality to the first and second mobile electronic devices 110,112. Example applications may include calendar applications, cellular telephone applications, instant messaging applications, email applications, photograph sharing applications, Internet browsing applications address book applications, and so forth.

The first and second mobile electronic devices 110,112 of FIG. 1 may be provided with a camera 196 that is configured to capture content such as still photographs and/or video by digitally recording images using an electronic image sensor.

Content captured by the camera 196 may be stored as digital content in memory 145. In embodiments, the digital image files may be stored using a variety of file formats. For example, digital photographs may be stored using a Joint Photography Experts Group standard (JPEG) file format. Other digital image file formats include Tagged Image File Format (TIFF), Raw data formats, and so on. Digital video may be stored using a Motion Picture Experts Group (MPEG) file format, an Audio Video Interleave (AVI) file format, a Digital Video (DV) file format, a Windows Media Video (WMV) format, and so forth. Exchangeable image file format (Exif) data may be included with digital image files to provide metadata about the image media. For example, Exif data may include the date and time the image content was captured, the location where the content was captured, and the like. Digital image content may be displayed by display 170 and/or transmitted to other devices and/or servers 105A,105B,105C via the communication network 115 (e.g., via an email or MMS text message).

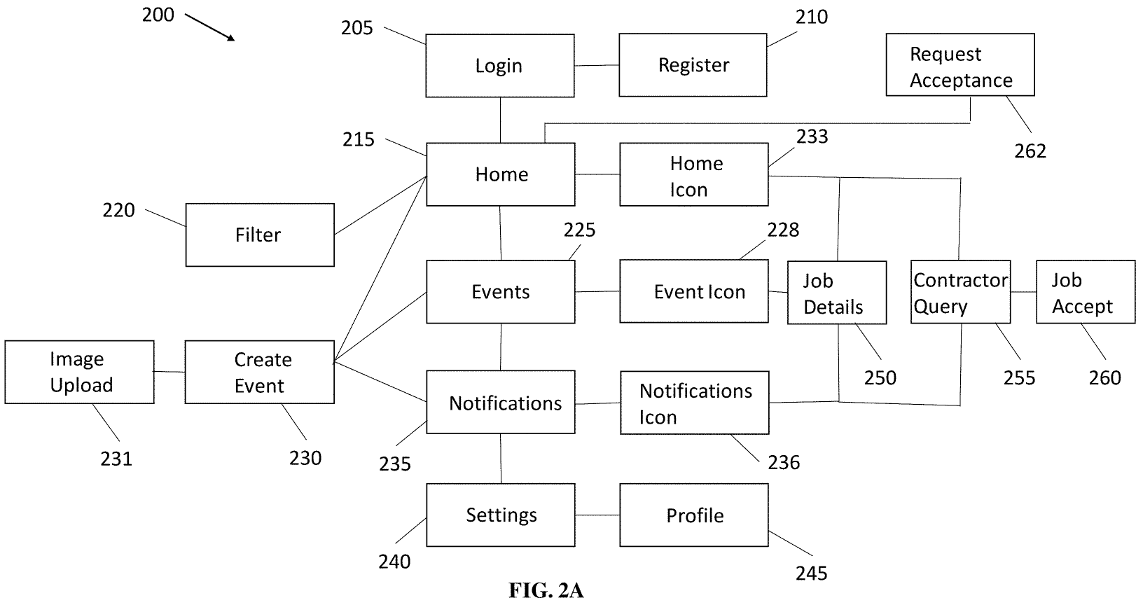

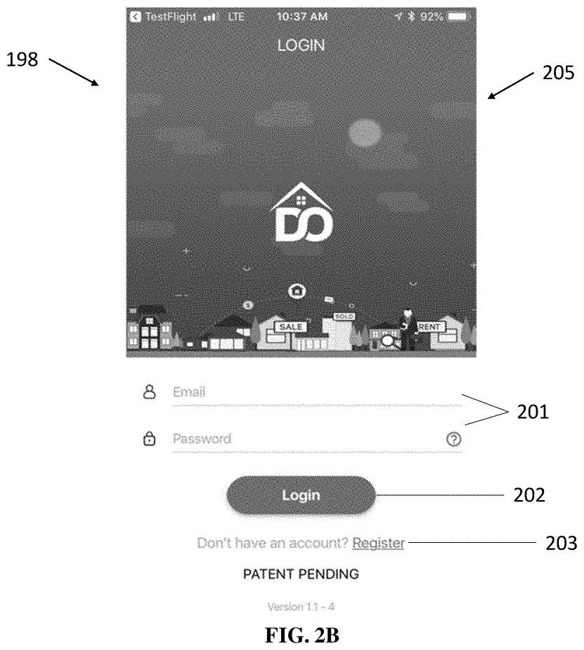

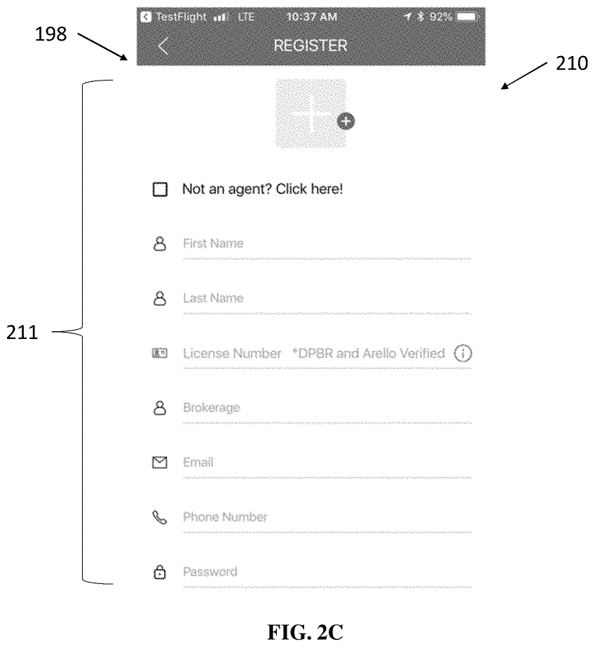

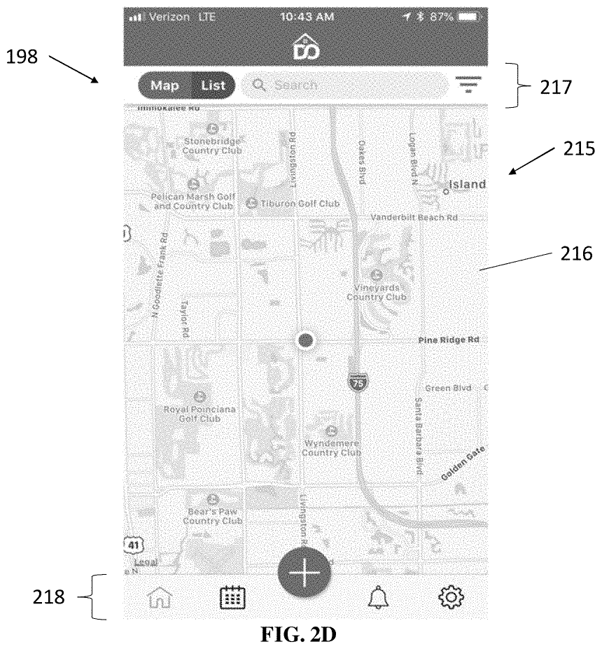

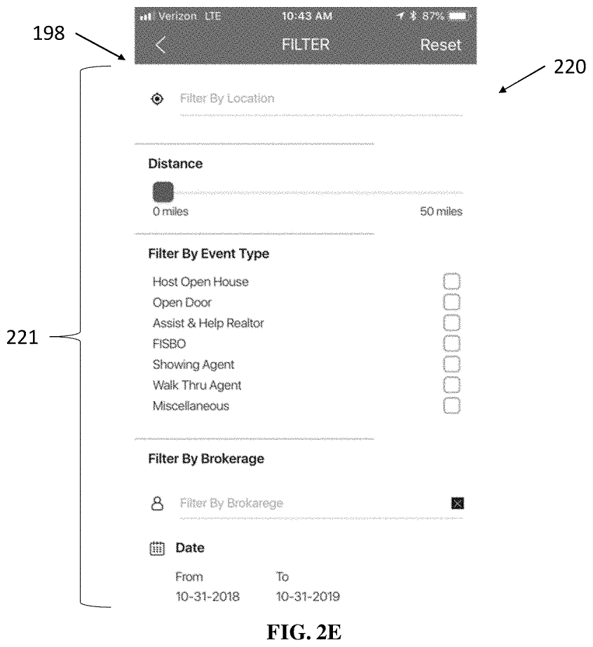

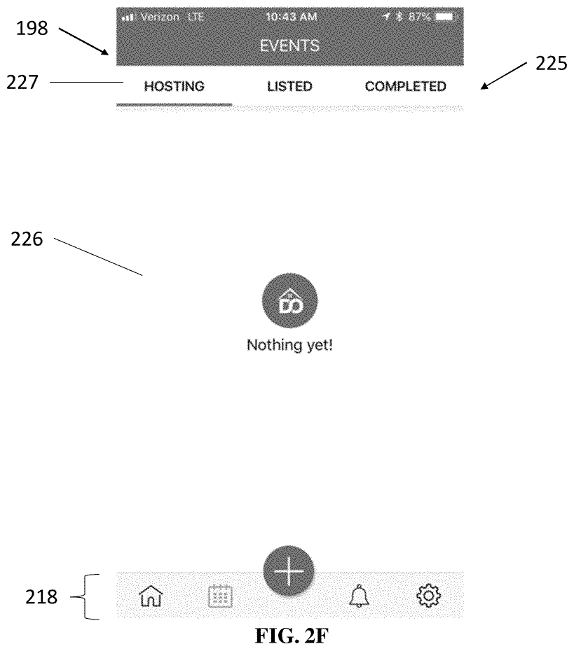

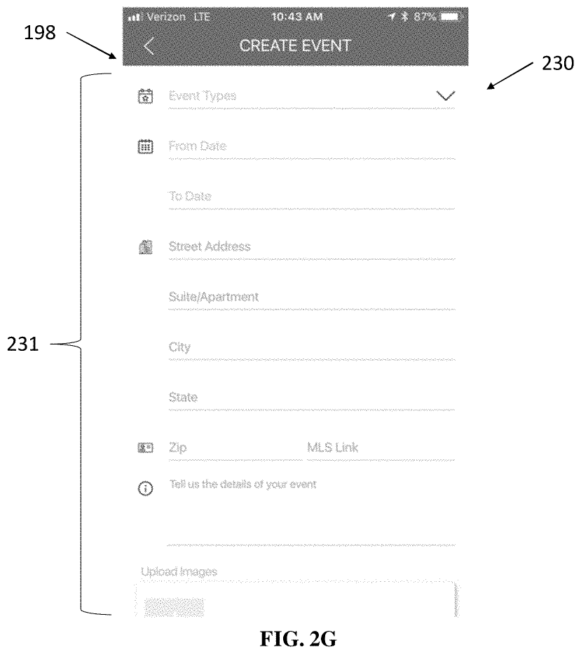

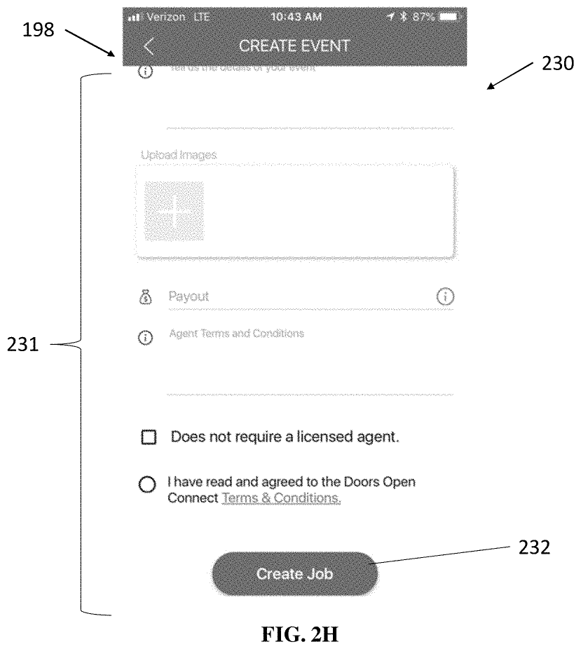

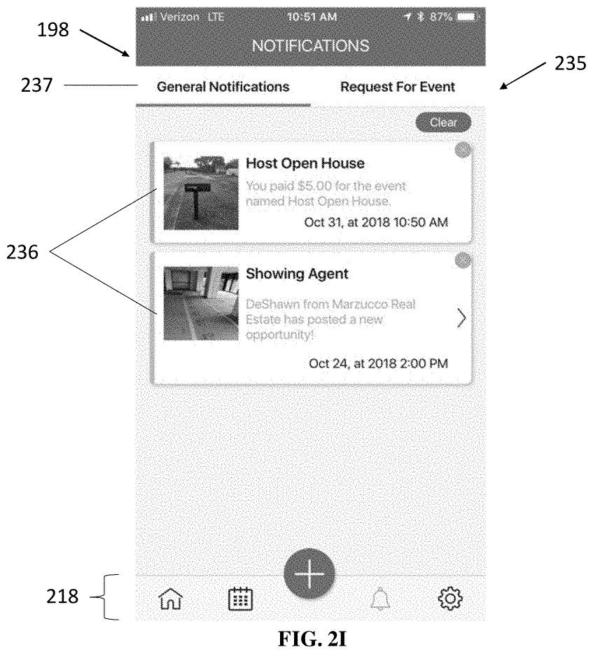

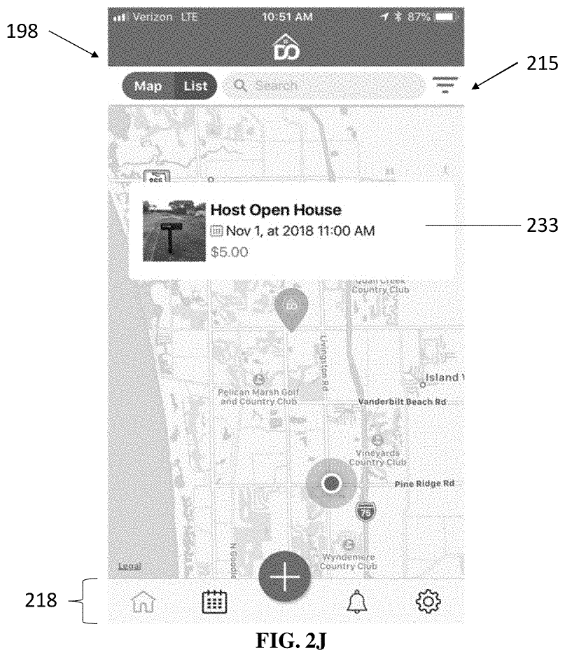

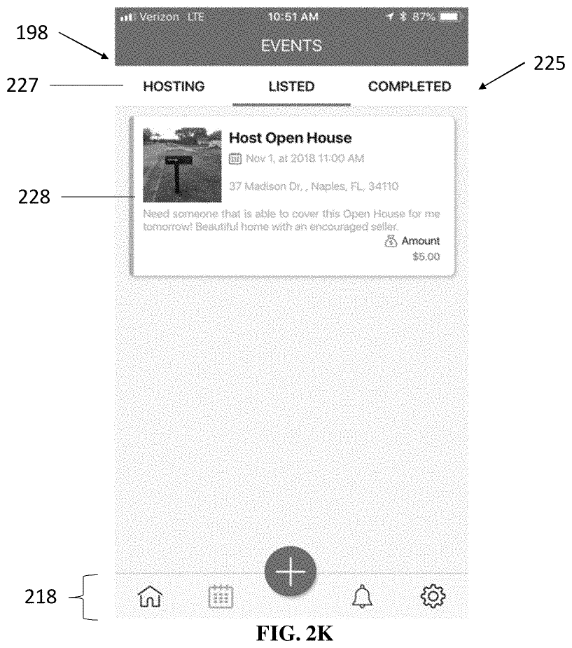

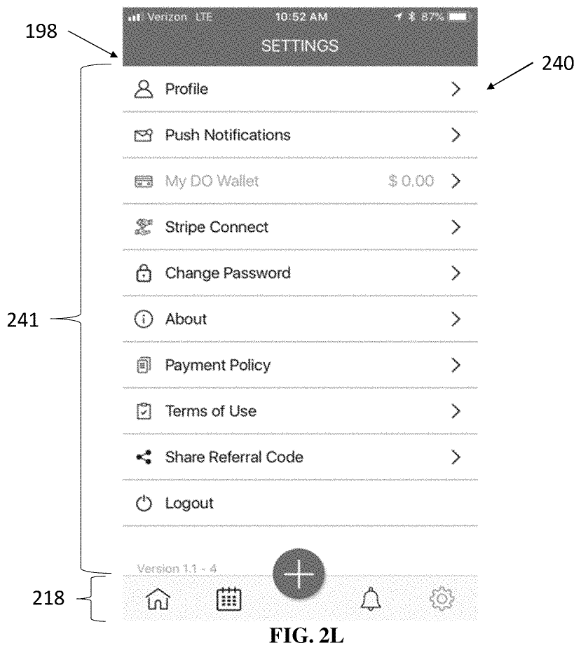

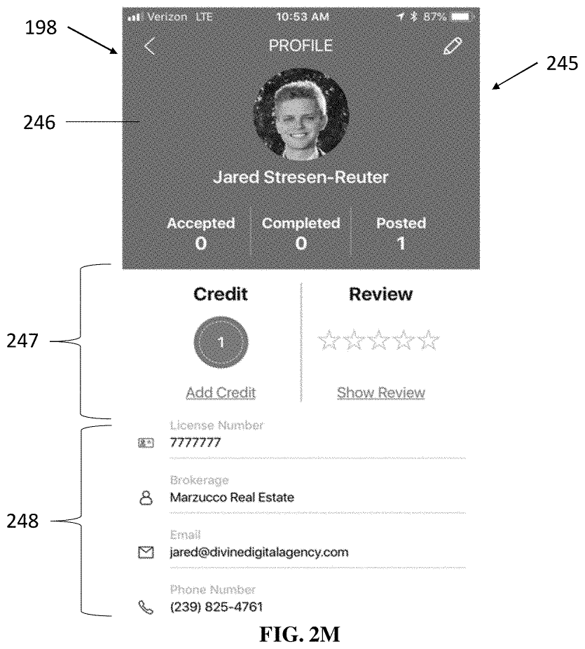

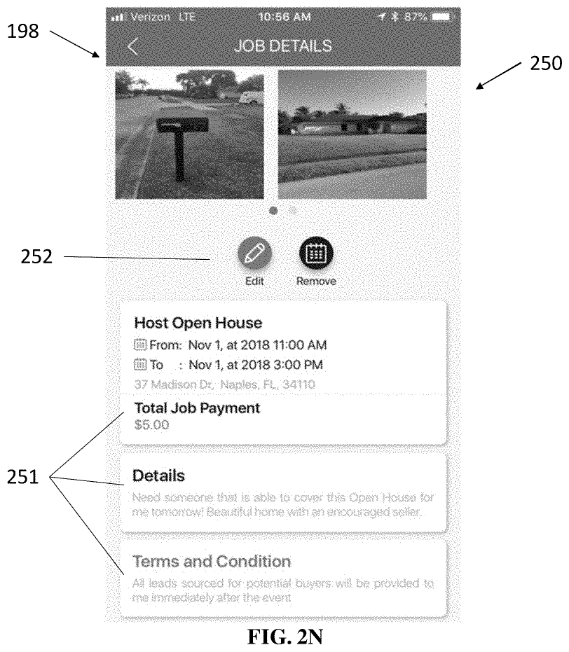

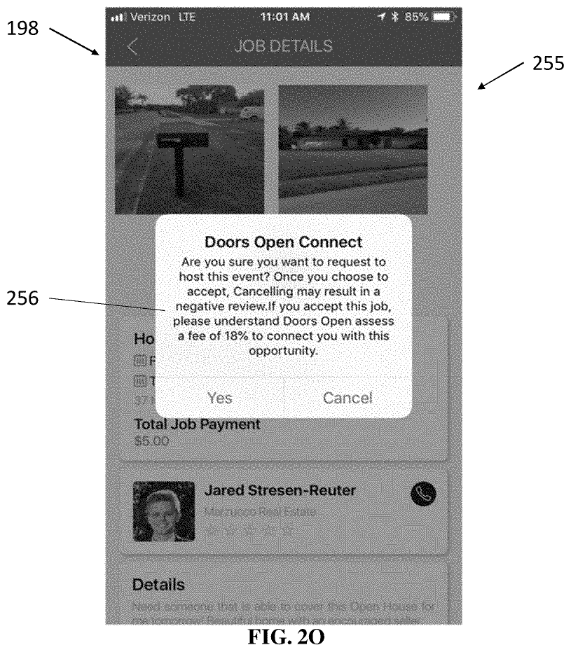

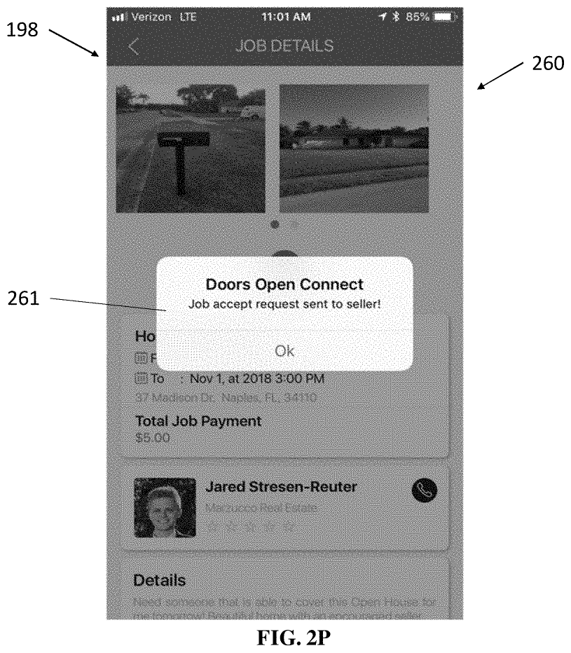

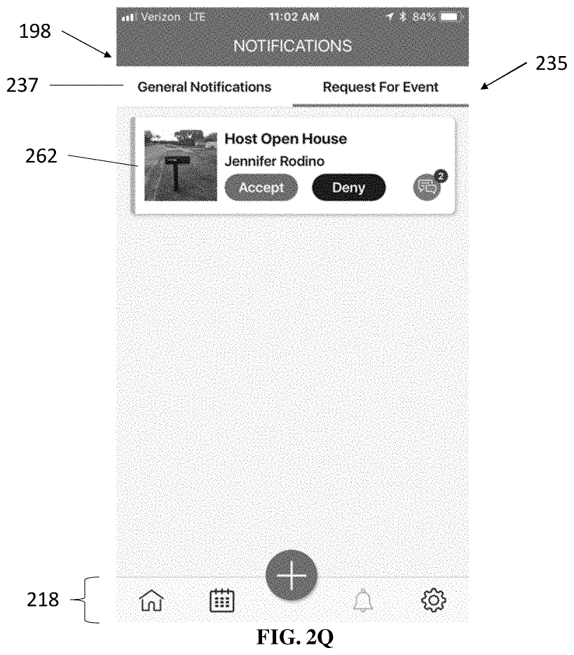

As shown in FIG. 1, the first and second mobile electronic devices 110,112 include a module 197, which is storable in the memory 145 and executable by the processor 135. The module 197 represents functionality to collect and to aggregate agent 102 and/or contractor 104 information with job information, as described in greater detail herein. For example, the module 197 may be configured to cause presentation of one or more information interfaces (e.g., input fields, etc.) to facilitate collection of the agent 102 and/or contractor 104 information (e.g., address, financial information, etc.), which is described in greater detail below with respect to FIGS. 2A through 2Q. The module 197 is also configured to cause transmission of the collected information to the central server 105C via the communication network 115. Thus, the job posting entity 105A and/or the banking entity 105B can access (via each entity's respective server) the information to assist in approving a job posting, approving job completion, and/or confirming a request to transfer funds.

Additionally, the agent 102 and contractor 104 information may reside on the central server 105C for future accessibility by approved entities. For example, the module 197 may be a stand-alone application configured to facilitate the posting of jobs for completion of the jobs by contractor 102 and subsequently transfer of funds from agent 102 to contractor 104.

The module 197 is configured to allow agent 102 and/or contractor 104 to create additional information, such as search criteria information. For example, a contractor 104 may manually input parameters concerning jobs desired by the contractor 104 to allow the contractor 102 to receive job opportunities that fall within that criteria.

When either the agent 102 or the contractor 104 initiates the module 197, module 197 is configured to cause the processor 135 to provide the agent 102 or the contractor 104 one or more interfaces and/or graphics associated with one or more real estate job postings (process in FIG. 2A). In embodiments, the module 197 may be configured to cause the processor 135 to initiate display of the interactive graphical interface 198. As shown in FIGS. 2B through 2Q, the graphical interface 198 may include one or more graphics associated with module 197. The graphics may convey information to the agent 102 or contractor 104 regarding details associated with job posting, job acceptance, funds transfer, etc.

FIG. 2A illustrates an example flow chart embodying a method 200 in accordance with example implementations of the present disclosure. Agent 102/contractor 104 may login via login page 205. If agent/contractor 104 does not have an account, agent 102/contractor 104 may be led to registration subroutine page 210 in order to register for an account for module 197. Once agent 102/contractor 104 is logged in, first or second mobile electronic device 110,112 may display home page 215 where job postings may be posted. In addition to home page 215, three additional main pages of module 197 may be accessible from home page 215 and include events page 225, notifications page 235, and settings page 240.

From home page 215, events page 225, notifications page 235, and settings page 240, multiple subpages may be accessed in order to carry out multiple functions. To create a job posting (event), agent 102/contractor 104 may access create event subroutine page 230. Images may be uploaded on a subsequent screen within an interactive graphical event element 231. Additionally, a secondary filter page 220 may be useful for contractors 104 to tailor job posting results based on specific criteria.

From home page 215, events page 225, and/or notifications page 235, job posting icons 228, location based job icons 233, and job posting notification icons 236 may be accessible by a contractor 104 looking for job postings. When an agent 102 actuates any one of the job posting icons 228, location based job icons 233, and job posting notification icons 236, agent 102 may be led to job details page 250 where agent 102 can amend or remove job postings. When a contractor 104 actuates any one of the job posting icons 228, location based job icons 233, and job posting notification icons 236, contractor 104 may be led to contractor query page 255 where contractor 102 can confirm acceptance of a job from a job posting. Once accepted, job accept page 260 may be displayed to contractor 104. Additionally, job acceptance request icon 262 may be viewable on home page 215 by agent 102 when contractor 104 has confirmed acceptance of a job from a job posting.

Furthermore, agent 102/contractor 104 may amend their profile within module 197 via profile subpage 245 accessible from settings page 240.

As shown in FIG. 2B, agent 102 or contractor 104 may peruse module 197 in different ways based on the functions they would like module 197 to perform. When the module 197 is opened on the first or second mobile electronic devices 110,112, agent 102/contractor 104 may be shown a login page 205 where the agent 102/contractor 104 can enter their login criteria in an interactive login section 201. Once agent 102/contractor 104 enters their credentials into interactive login section 201, agent 102/contractor 104 may press the interactive login graphic 202 in order to access the rest of module 197. If the agent 102/contractor 104 has not logged in before with module 197, the agent 102/contractor 104 may interact with the interactive registration 203 (graphical representation of a button, etc.) in order to access a registration subroutine page 210 (FIG. 2C). Once on the registration subroutine page 210, agent 102/contractor 104 may enter personal information into interactive personal information section 211. Information entered may additionally include a photo/picture that may be taken by camera 196 and accessed from a module external to module 197.

As shown in FIG. 2D, agent 102/contractor 104 may view and/or create job postings on home page 215. Upper interactive bar 217 comprises multiple interactive graphical representations that may perform functions such as, but not limited to, displaying job postings in map mode or list mode, searching via keywords, and filtering jobs via specific parameters. Displayed below the upper interactive bar 217 is map region 216. Map region 216 may display interactive graphical representations of job postings when a job is located in a location displayed by map region 216. Lower interactive bar 218 may display a number of interactive graphical representations that represent links to main pages in module 197 besides home page 215 that include an events page 225, a notifications page 235, and a settings page 240. FIG. 2J displays home page 215 including a location based job icon 233. When a job is available for a contractor 104, location based job icons 233 may appear on home page 215.

When a filter button is engaged (right hand side of upper interactive bar 217), the first or second mobile electronic device 110,112 may display secondary filter page 220. Secondary filter page 220 may include a plurality of interactive graphical filter elements 221 that may allow agent 102/contractor 104 to limit or expand search criteria. Criteria may include, but is not limited to, location, distance, event (job posting) type, brokerage, and date. When the criteria is amended, map region 216 may display more or less job postings than had originally been shown.

As shown in FIG. 2F, events page 225 may display job postings that have either been accepted by, listed, or completed by agent 102/contractor 104 (job postings may be separated into the categories of hosting, listed, or completed, the categories of which may be incorporated as tabs in events tab bar 227). Job postings may be found in the events display zone 226 (as shown, there are no events). Via events page 225, agent 102/contractor 104 may create an event using a creation icon found in the lower interactive bar 218 (depicted as a plus sign inside of a circle). It is noted that the creation icon may be found on not only the events page 225 but may also be found on the home page 215 and the notifications page 235 as well. Actuating the creation icon may lead agent 102/contractor 104 to a create event subroutine page 230, as shown in FIG. 2G. Create event subroutine page 230 may include a plurality of interactive graphical event elements 231 that may allow agent 102/contractor 104 to input information relating to a job posting to be created. Criteria may include, but is not limited to, event (job posting) type, dates, address, and job details. Additional interactive graphical event elements 231 may be shown in FIG. 2H, which may include the criteria of images (upload), payout (cost/job reward amount), terms and conditions, real estate license confirmation, and terms agreement. Once the desired criteria is added by agent 102/contractor 104, a create event icon 232 at the bottom of create event subroutine page 230 may be actuated. When the create event subroutine page 230 is actuated, a job posting may be viewable on at least one of the home page 215, the events page 225, and the notifications page 235.

As shown in FIG. 2K, events page 225 displays a job posting icon 228 that may be representative of a job being posted (the icon 228 shown is categorized as a job posting). Icon 228 may include detailed information about a job posting and may include, but is not limited to dates, locations, descriptions, details, and payment information. More generally, job posting icons 228 may be separated into the categories of hosting, listed, or completed. To view any type of the job posting icons 228, agent 102/contractor 104 may engage events tab bar 227.

As shown in FIG. 21, notifications page 235 may display at least one job posting notification icon 236 that may be representative of update messages concerning at least one job being posted. Update messages may include, but are not limited to job updates, payment updates, and posting updates. The at least one job posting notification icon 236 may be removed from the page by engaging a portion of the icons 236. Additionally, the at least one job posting notification icon 236 may be separated into general notifications and requests. To view either type of the at least one job posting notification icon 236, agent 102/contractor 104 may engage interactive tab section 237.

As shown in FIG. 2L, settings page 240 may display variables that may alter the functionality of module 197 and/or may provide general information. Settings page 240 may include a plurality of interactive settings elements 241 that may allow agent 102/contractor 104 to alter the functionality of module 197 and/or provide general information. Subject matter found in the interactive settings elements 241 may include, but is not limited to, profile, push notifications, wallet, stripe connect, password amending, about (the module 197), payment policy, terms of use, referral code sharing, and logging out. For example, when agent 102/contractor 104 actuates the profile interactive settings element 241, profile subpage 245 found in FIG. 2M may show information on agent 102/contractor 104. Information may be separated into three sections: a profile section 246, an attributes section 247, and a general information section 248. The profile section 246 may include an image and job information. The attributes section 247 may include credibility criteria concerning agent 102/contractor 104 (such as credit and ratings). The general information section 248 may include general information about agent 102/contractor 104 (license number, brokerage, email, phone number, etc.).

As shown in FIG. 2N, job details page 250 may be accessed by agent 102 for amending details of a job posting. Job detail sections 251 may provide information concerning a job posting and may include, but is not limited to date, address, payment/compensation information, general details, and terms and conditions. Engageable icons 252, when engaged, may allow an agent 102 to amend or remove a job posting. Agent 102 may access job details page 250 by engaging at least one of job posting icon 228, location based job icon 233, and job posting notification icon 236.

As shown in FIG. 20, contractor query page 255 may be accessed by contractor 104 for accepting a job from a job posting. Contractor 104 may access contractor query page 255 by engaging at least one of job posting icon 228, location based job icon 233, and job posting notification icon 236. Engageable query 256 may provide options for contractor 104 to perform a job (host) posted by agent 102. When contractor 104 engages one of the “yes” or “cancel” icons, commands will be sent to server 105A to send a message back to mobile electronic device 112. For example, job accept page 260 found in FIG. 2P may be displayed by mobile electronic device 112 when contractor 104 actuates the “yes” icon found within engageable query 256. Job acceptance icon 261 may appear on job accept page 260 to confirm acceptance of the job by contractor 104.

As shown in FIG. 2Q, notifications page 235 may display at least one job acceptance request icon 262 that may be representative of a request to confirm contractor 104 for a job posted by agent 102. Additionally, the at least one job acceptance request icon 262 may be denoted as a request in interactive tab section 237.

In embodiments, mobile electronic devices 110,112 may include GPS connectivity so that mobile electronic devices 110,112 may display their locations to agent 102/contractor 104. Using this function, mobile electronic device 112 may provide location data to module 197 so that a contractor's 104 location may be tracked by module 197. Location data may then be configured into map or location text information on mobile electronic device 110 so that agent 102 can ensure that contractor 104 is actually at the location of a job (for accountability purposes). Once contractor 104 has completed a job, contractor 104 may “check out” of a job by amending a status of a job as “complete” within module 197. Agent 102 may reconfirm the “complete” status of contractor 104 within module 197 as well.

It is noted that additional features may be performed/utilized within module 197. Chat features may be utilized within module 197 to keep agent 102 and contractor 104 in communication during any time agent 102 and contractor 104 are using module 197. Job count information may be displayed on profile subpage 245 for either agent 102 or contractor 104 so that job count information is viewable to anyone utilizing module 197. Additionally, individuals utilizing module 197 may rate and/or review agents 102 and/or contractors 104 based on interactions and work completed.

In embodiments, agents 102 may directly offer jobs to contractors 104 before making it into a job posting icon 228 publicly viewable within module 197. This may be carried out via a chat feature or private message feature within module 197. Additionally, contractors 104 may request, from an agent, to host open house jobs chosen from a list of an agent's 102 active listings (viewable within module 197) regardless of whether the jobs have been created into a public job posting icon 228 or not. More specifically, contractors 104 may review agents' 102 profiles (within profile subpage 245) and listings including location information and may then request dates and times when the contractors 104 would like to host jobs, such as open houses. Agents 102 may then choose to deny or approve the contractors' 104 requests. Communication between agents 102 and contractors 104 may be carried out via the chat features or private message features within module 197. Additionally, contractor 104 query information for hosting a job may be inserted into one or more designated fillable fields and then may be subsequently sent via actuation of a “send” engageable icon.

It is noted that information exchanged between first and second mobile electronic devices 110,112 and servers 105A,105B,105C may be temporarily or permanently stored within database 122.

For the purposes of this disclosure, it is noted that agent 102 may refer to a real estate agent posting a job on module 197 and contractor 104 may refer to an individual, whether a real estate agent or not, accepting and performing a job found on module 197.

For the purposes of this disclosure, the terms “host” and “agent” may be synonymous.

For the purposes of this disclosure, the terms “event”, “job” and “job posting” may be synonymous.

It is noted that the term “user”, referring to users of module 197, may refer to either agent 102 or contractor 104.

Unless otherwise defined, all technical and scientific terms used herein have the same meanings as are commonly understood by one of ordinary skill in the art to which this disclosure belongs. Although methods similar or equivalent to those described herein can be used in the practice or testing of the present disclosure, suitable methods are described herein.

All publications, patent applications, patents, and other references mentioned herein are incorporated by reference in their entirety. In case of conflict, the patent specification, including definitions, will prevail. In addition, the materials, methods, and examples are illustrative only and not intended to be limiting.

It will be appreciated by persons skilled in the art that the present disclosure is not limited to what has been particularly shown and described hereinabove. Rather, the scope of the present disclosure is defined by the appended claims and includes both combinations and sub-combinations of the various features described hereinabove as well as variations and modifications thereof, which would occur to persons skilled in the art upon reading the foregoing description.

What is claimed is:

1. A system for managing and allocating real estate related services, the system comprising:
a plurality of servers connected via a network to at least one electronic device accessible by real estate agents and at least one electronic device accessible by contractors, at least one of the plurality of servers configured to:
receive, over the network, at least one real estate service request and at least one contractor request;
allocate and send the at least one real estate service request to a second electronic device accessible by at least one of the contractors;
allocate and send the at least one contractor request to a first electronic device accessible by at least one of the real estate agents;
wherein, in response to the allocating of the at least one contractor service request, at least one of the plurality of servers confirms at least one matched real estate service request and contractor service request from the at least one matched real estate service request and the at least one contractor service request.

2. The system of claim 1, wherein the at least one real estate service request comprises a single request to a single contractor.

3. The system of claim 1, wherein each of the at least one real estate service requests comprises accessibility to a profile of a real estate agent.

4. The system of claim 1, wherein each of the at least one contractor service requests comprises accessibility to a profile of a contractor.

5. The system of claim 1, wherein the at least one real estate service request is accessible via a visible mapping component on at least one of the first electronic device and the second electronic device.

6. The system of claim 1, wherein a first of the plurality of servers is associated with a job posting entity and a second of the plurality of servers is associated with a banking entity.

7. The system of claim 1, wherein the first of the plurality of servers associated with the job posting entity is configured to receive, allocate, and confirm the at least one real estate service request and the at least one contractor service request.

8. The system of claim 1, wherein the second of the plurality of servers associated with the banking entity manages and stores data representing at least one real estate agent's banking information and at least one contractor's banking information to properly allocate funds for completed jobs associated with the at least one real estate service request.

9. The system of claim 1, wherein the at least one real estate service request and the at least one contractor service request is accessible within a module stored on each of the first electronic device and the second electronic device.

10. The system of claim 9, wherein a status of at least one job allocated to at least one contractor is accessible and manipulatable by the at least one contractor and at least one real estate agent within the module.

11. A method for managing and allocating real estate related services, the method comprising:
receiving, by at least one of a plurality of servers, at least one real estate service request from at least one first electronic device accessible by real estate agents;
approving the at least one real estate service request;
allocating and sending, by at least one of a plurality of servers over a network, at least one real estate service request to at least one second electronic device accessible by contractors;
and
receiving, by the at least one of a plurality of servers, at least one contractor service request via the at least one second electronic device accessible by contractors in response to the allocating and sending of the at least one real estate service request.

12. The method of claim 11, wherein the at least one real estate service request comprises a single request to a single contractor.

13. The method of claim 11, further comprising:
approving the at least one contractor service request;
allocating and sending, by the at least one of a plurality of servers over a network, the at least one real estate service request that has been matched with the at least one contractor service request to the at least one first electronic device accessible by real estate agents; and
receiving, by the at least one of a plurality of servers, at least one confirmation of a matched real estate service request and contractor service request from the at least one first electronic device accessible by real estate agents.

14. The method of claim 13, wherein, in response to the receiving of the confirmation, at least one of the plurality of servers confirms the confirmation from the at least one first electronic device accessible by real estate agents.

15. The method of claim 11, further comprising accessing a profile of a real estate agent within each of the at least one real estate service requests.

16. The method of claim 11, further comprising accessing a profile of a contractor within each of the at least one contractor service requests.

17. The method of claim 11, further comprising managing and storing data representing at least one real estate agent's banking information and at least one contractor's banking information in the second of the plurality of servers associated with a banking entity.

18. The method of claim 17, further comprising allocating, via the second of the plurality of servers associated with the banking entity, funds for completed jobs associated with the at least one real estate service request.

19. The method of claim 11, further comprising accessing the at least one real estate service request and the at least one contractor service request within a module stored on each of the first electronic device and the second electronic device.

20. The method of claim 19, further comprising manipulating a status of at least one job allocated to at least one contractor by the at least one contractor and at least one real estate agent within the module.
